(19) United States
(12) Patent Application Publication
(10) Pub. No.: US 2026/0048571 A1
(43) Pub. Date: Feb. 19, 2026

(54) WALLPAPER WITH AN ALUMINUM FOIL STRUCTURAL LAYER

(71) Applicant: Henan Keqian Information Technology Co., Ltd., Zhengzhou (CN)

(72) Inventor: Shijian Yu, Zhengzhou (CN)

(21) Appl. No.: 18/807,862

(22) Filed: Aug. 16, 2024

(51) Int. Cl. B32B 15/082; B32B 7/06; B32B 7/12; B32B 15/20; B32B 25/08; B32B 25/20; B32B 27/30

(52) U.S. Cl. CPC B32B 15/082; B32B 7/06; B32B 7/12; B32B 15/20; B32B 25/08; B32B 25/20; B32B 27/304; B32B 2607/02

(57) ABSTRACT

A wallpaper with an aluminum foil structural layer comprises a wallpaper body, and the wallpaper body comprises a PVC printing layer, an anti-tensile structural layer, an adhesive layer and a silicone layer lining paper; the PVC printing layer, anti-tensile structural layer, adhesive layer and silicone layer lining paper are disposed sequentially from outside to inside, the PVC printing layer and anti-tensile structural layer being affixed to each other by high temperature, a top of the adhesive layer being affixed to a bottom of the anti-tensile structural layer, and its bottom end is affixed to a top of the silicone layer lining paper. The invention added aluminum foil base layer as the anti-tensile structural layer in the wallpaper structure; compared to other traditional PVC layer, it has tear-resistant, non-transparent, non-stretching self-adhesive and other properties, aluminum foil material properties are more stable, which cannot be torn even tugging and pulling vigorously.

### 1. TECHNICAL FIELD

The invention belongs to the technical field of wallpaper, specifically relates to a wallpaper with an aluminum foil structural layer.

### 2. BACKGROUND ART

Traditional self-adhesive wallpaper uses PVC material, temperature changes will cause thermal expansion and contraction of PVC, resulting in products easy to tear, bottom being visible, thin, easy to stretch, etc., making it difficult for the customer to operate in the using process, and will damage the product; most of the wallpaper in the upgrading is to change the ratio of PVC to improve the situation of easy to tear, bottom being visible, thin, easy to stretch, but the different temperatures lead to the unfixed ratio of materials, and the wallpaper material is very unstable.

In order to solve the above technical problems, a kind of wallpaper with aluminum foil structural layer needs to be studied urgently.

### 3. SUMMARY OF THE INVENTION

In order to enhance the stability of the wallpaper material and to extend its life cycle, the technical solution provided by the invention is a wallpaper with an aluminum foil structural layer, comprising a wallpaper body, and the wallpaper body comprises a PVC printing layer, an anti-tensile structural layer, an adhesive layer and a silicone layer lining paper; the PVC printing layer, anti-tensile structural layer, adhesive layer and silicone layer lining paper are disposed sequentially from outside to inside, the PVC printing layer and anti-tensile structural layer being affixed to each other by high temperature, a top of the adhesive layer being affixed to a bottom of the anti-tensile structural layer, and its bottom end is affixed to a top of the silicone layer lining paper.

Further, the anti-tensile structural layer is an aluminum foil base layer.

Further, the top of said adhesive layer is attached to a bottom of the aluminum foil base layer.

Further, the adhesive layer and silicone layer lining paper form a wallpaper bonding layer.

Compared with the prior art, the invention has the following advantages:

The invention added aluminum foil base layer as the anti-tensile structural layer in the wallpaper structure; compared to other traditional PVC layer, it has tear-resistant, non-transparent, non-stretching self-adhesive and other properties, aluminum foil material properties are more stable, which cannot be torn even tugging and pulling vigorously, and can be covered in any dirty wall and furniture and will not see through the bottom; it will not be stretched because of temperature changes, reducing the difficulty of operation and improving the service life of wallpaper.

The aluminum foil material in the invention features low moisture absorption, low air permeability, light weight, easy processing, corrosion resistance, and good reflective insulation properties, and it has excellent heat insulation, moisture resistance, and electromagnetic radiation resistance, which makes the room have a shielding effect, and reduces the diffusion of the indoor energy to the wall and the top wall, and prevents the invasion of the cold and hot air from the outside; by adding the aluminum foil base layer into the wallpaper structure as described above, the wallpaper structure in the invention is multifunctional, so that the product of the invention not only has good anti-static performance, but also has excellent performance in heat insulation, moisture resistance, and electromagnetic radiation resistance.

### 4. BRIEF DESCRIPTION OF ACCOMPANY DRAWINGS

FIG. 1 is the first structural diagram of the wallpaper with an aluminum foil structural layer provided by the invention;

FIG. 2 is the second structural diagram of the wallpaper with an aluminum foil structural layer provided by the invention;

Wherein: 1 PVC printing layer, 2 anti-tensile structural layer, 3 adhesive layer, 4 silicone layer lining paper.

### 5. SPECIFIC EMBODIMENT OF THE INVENTION

The invention is further described in detail hereinafter with reference to the drawings.

With reference to the drawings, the invention is further described in detail.

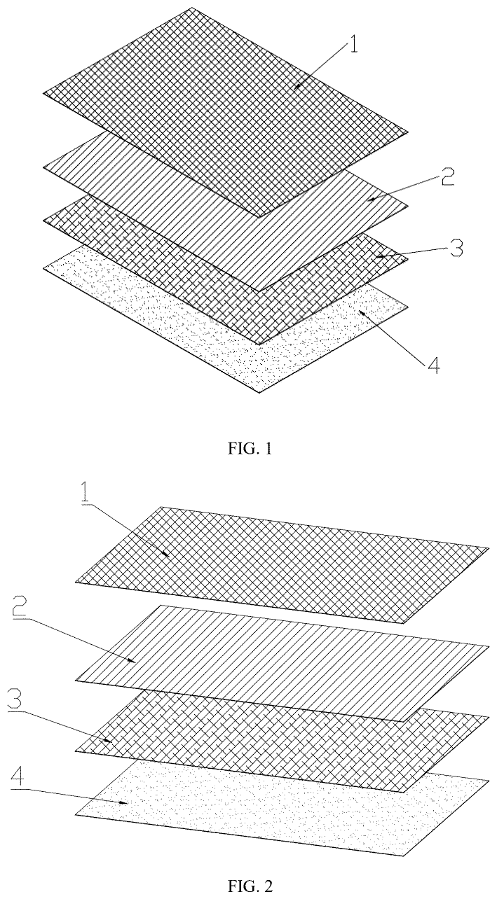

As shown in FIG. 1 and FIG. 2, a wallpaper with an aluminum foil structural layer in specific implementation comprises a wallpaper body, and the wallpaper body comprises a PVC printing layer 1, an anti-tensile structural layer 2, an adhesive layer 3 and a silicone layer lining paper 4; the PVC printing layer 1, anti-tensile structural layer 2, adhesive layer 3 and silicone layer lining paper 4 are disposed sequentially from outside to inside, the PVC printing layer 1 and anti-tensile structural layer 2 being affixed to each other by high temperature, a top of the adhesive layer 3 being affixed to a bottom of the anti-tensile structural layer 2, and its bottom end is affixed to a top of the silicone layer lining paper 4.

### Embodiment

When the invention is in use, as aluminum foil base layer is added in the wallpaper structure and the traditional PVC wallpaper structure has been changed, aluminum foil material in the application of wallpaper is more stable compared to PVC, not easy to tear, non-transparent, and non-stretching, reducing the difficulty of operation and improving the service life of wallpaper.

Wherein, the wallpaper body comprises a PVC printing layer 1, an anti-tensile structural layer 2, an adhesive layer 3 and a silicone layer lining paper 4, and the PVC printing layer 1 and anti-tensile structural layer 2 are affixed to each other by high temperature; a top of the adhesive layer 3 is affixed to a bottom of the anti-tensile structural layer 2, and its bottom end is affixed to a top of the silicone layer lining paper 4. When in use, the silicone layer lining paper 4 at a bottom end can be directly torn off, and then the above wallpaper structural layers with aluminum foil can be pasted on the wall surface, and the above wallpaper structure is able to cover any dirty wall and furniture, which is simple to operate and more practical.

This product is a kind of self-adhesive wallpaper, mainly used in home decoration of scene walls. Wherein, the aluminum foil material in the invention features low moisture absorption, low air permeability, light weight, easy processing, corrosion resistance, and good reflective insulation properties, and it has excellent heat insulation, moisture resistance, and electromagnetic radiation resistance, which makes the room have a shielding effect, and reduces the diffusion of the indoor energy to the wall and the top wall, and prevents the invasion of the cold and hot air from the outside; by adding the aluminum foil base layer into the wallpaper structure as described above, the wallpaper structure in the invention is multifunctional, so that the product of the invention not only has good anti-static performance, but also has excellent performance in heat insulation, moisture resistance, and electromagnetic radiation resistance.

As a further elaboration of the invention, the anti-tensile structural layer 2 is an aluminum foil base layer. The above structure of the aluminum foil base layers can increase the tear-resistant and anti-stretching properties of the tear-resistant wallpaper and improve the service life of the wallpaper.

As a further elaboration of the invention, the top of said adhesive layer 3 is attached to a bottom of the aluminum foil base layer. The setting of the adhesive layer 3 facilitates the bonding and fixing of the wallpaper structural layer of the aluminum foil described above to any dirty wall and furniture, which is more practical and flexible.

As a further elaboration of the invention, the adhesive layer 3 and silicone layer lining paper 4 form a wallpaper bonding layer.

The invention and its embodiments have been described above, but the description is not limited thereto; only one embodiment of the invention is shown in the drawings, and the actual structure is not limited thereto. In general, it is to be understood by those skilled in the art that non-creative design of structural forms and embodiments that are similar to the technical solutions without departing from the spirit of the invention shall all fall within the protective scope of the invention.

The above shows and describes the basic principles and main features of the invention and the advantages of the invention. Those skilled in the art should understand that the invention is not limited by the above embodiments, and that the above embodiments and the description in the specification are only illustrative of the principles of the invention, and that there will be various changes and improvements to the invention without departing from the spirit and scope of the invention, which fall within the scope of the invention claimed to be protected. The scope of protection claimed for the invention is defined by the appended claims and their equivalents.

1. A wallpaper with an aluminum foil structural layer, comprising a wallpaper body, and the wallpaper body comprising a PVC printing layer, an anti-tensile structural layer, an adhesive layer and a silicone layer lining paper; the PVC printing layer, anti-tensile structural layer, adhesive layer and silicone layer lining paper are disposed sequentially from outside to inside, the PVC printing layer and anti-tensile structural layer being affixed to each other by high temperature, a top of the adhesive layer being affixed to a bottom of the anti-tensile structural layer, and its bottom end is affixed to a top of the silicone layer lining paper.

2. The wallpaper with an aluminum foil structural layer of claim 1, wherein the anti-tensile structural layer is an aluminum foil base layer.

3. The wallpaper with an aluminum foil structural layer of claim 2, wherein the top of the adhesive layer is attached to a bottom of the aluminum foil base layer.

4. The wallpaper with an aluminum foil structural layer of claim 1, wherein the adhesive layer and silicone layer lining paper form a wallpaper bonding layer.
